(19) United States
(12) Patent Application Publication
(10) Pub. No.: US 2019/0197601 A1
(43) Pub. Date: Jun. 27, 2019

(54) SaaS CLOUD-BASED SYSTEM FOR SOURCING, PROCURING AND SELLING ENGINEERING COMPONENTS

(71) Applicant: Vijayakumar AYYADURAI, Highlands Ranch, CO (US)

(72) Inventor: Vijayakumar AYYADURAI, Highlands Ranch, CO (US)

(21) Appl. No.: 16/232,872

(22) Filed: Dec. 26, 2018

Related U.S. Application Data
(60) Provisional application No. 62/610,861, filed on Dec. 27, 2017.

(51) Int. Cl. G06Q 30/06; G06Q 10/08; G06Q 30/02

(52) U.S. Cl. CPC G06Q 30/0635; G06Q 30/0282; G06Q 10/083

(57) ABSTRACT

A system for sourcing, procuring and selling engineering components, includes discovery engine for receiving a request from a buyer to search suppliers capable of providing an engineering component based on a plurality of attributes, for setting maximum and minimum value for each attribute, for assigning weightage to each attribute, and for determining an aggregate relevance score for suppliers. System also includes a drawing engine for receiving drawing of the engineering component from the buyer, associating drawing with request for quotation (RFQ), and storing drawing. System includes RFQ engine for generating RFQ to be sent to suppliers by buyer, and for receiving response to RFQ by buyer from suppliers, where buyer and suppliers access the drawing associated with RFQ. System also includes order engine for facilitating order for the engineering component, shipment engine for creating invoice for the order and facilitating shipment, and payment engine to facilitate payment for the order. System also includes buyer engine to handle all the requests initiated by the buyer. System also includes supplier engine to handle all the requests initiated by the supplier. System also includes chat engine to manage all the communication between buyer and supplier. System also includes feedback engine to manage the feedback from suppliers and buyers.

### TECHNICAL FIELD

Embodiments of the disclosure relate generally to a SaaS (software as a service) cloud-based system and, more particularly to, a SaaS cloud-based system for sourcing, procuring and selling engineering components.

### BACKGROUND

Sourcing, procuring and selling an engineering component is a long drawn and complex process which makes it highly difficult to manage. In addition, the existing processes and systems lack effectiveness which leads to high transaction cost and increased lead time.

Existing systems do not provide a comprehensive solution to manage the procurement process end to end. Even with the combined use of various existing systems to manage different stages of the procurement process, interoperability issues between those systems are bound to happen. Moreover, the cost of doing business could increase significantly with the use of multiple disparate systems.

Hence, there is a need for a solution that improves on the existing solutions by implementing a comprehensive solution that manage the entire workflow of sourcing and procuring engineering components.

### SUMMARY

In one example, a SaaS (software as a service) cloud-based system for sourcing, procuring and selling engineering components is provided. The system includes a discovery engine for receiving a request from a buyer to search suppliers capable of providing an engineering component based on a plurality of attributes, for setting maximum and minimum value for each attribute, for assigning weightage to each attribute, and for determining an aggregate relevance score for the suppliers using the plurality of attributes. The system also includes a drawing engine for receiving a drawing of the engineering component from the buyer, associating the drawing with a request for quotation (RFQ), storing the drawing, and accessing the drawing associated to the RFQ. Further, the system includes a RFQ engine for generating the RFQ to be sent to the suppliers by the buyer, and for receiving response to the RFQ by the buyer from the suppliers. The system also includes an order engine for facilitating an order for the engineering component, wherein the order is placed by the buyer to a supplier selected from the suppliers. Furthermore, the system includes a shipment engine for creating an invoice for the order and facilitating shipment of the order. In addition, the system includes a payment engine to facilitate payment for the order.

In one example, a method for sourcing, procuring and selling engineering components. The method includes receiving a request from a buyer to search suppliers capable of providing an engineering component based on a plurality of attributes. The method also includes setting maximum and minimum value for each attribute. Additionally, the method includes assigning weightage to each attribute. Further, the method includes determining an aggregate relevance score for the suppliers using the plurality of attributes. In addition, the method includes receiving drawing of the engineering component from the buyer. The method also includes associating the drawing with a request for quotation (RFQ). Further, the method includes storing the drawing and accessing the drawing associated to the RFQ. The method also includes generating the RFQ to be sent to the suppliers by the buyer. Furthermore, the method includes receiving response to the RFQ by the buyer from the suppliers. The method also includes facilitating an order for the engineering component, wherein the order is placed by the buyer to a supplier selected from the suppliers. Further, the method includes facilitating payment for the order. Additionally, the method includes creating an invoice for the order. The method also includes facilitating shipment of the order.

In one example, a server is provided. The server includes a memory to store instructions. The server also includes a processor responsive to the instructions stored in the memory to perform a method for sourcing, procuring and selling engineering components. The method includes receiving a request from a buyer to search suppliers capable of providing an engineering component based on a plurality of attributes. The method also includes setting maximum and minimum value for each attribute. Additionally, the method includes assigning weightage to each attribute. Further, the method includes determining an aggregate relevance score for the suppliers using the plurality of attributes. In addition, the method includes receiving drawing of the engineering component from the buyer. The method also includes associating the drawing with a request for quotation (RFQ). Further, the method includes storing the drawing and accessing the drawing associated with the RFQ. The method also includes generating the RFQ to be sent to the suppliers by the buyer. Furthermore, the method includes receiving response to the RFQ by the buyer from the suppliers. The method also includes facilitating an order for the engineering component, wherein the order is placed by the buyer to a supplier selected from the suppliers. Further, the method includes facilitating payment for the order. Additionally, the method includes creating an invoice for the order. The method also includes facilitating shipment of the order.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the present disclosure.

FIG. 1 is a block diagram of a system for sourcing, procuring and selling, according to embodiments as disclosed herein;

FIG. 2 illustrates an environment, in which various embodiments disclosed herein may be practiced;

FIG. 3 is a flowchart indicating a method for sourcing, procuring and selling, according to embodiments as disclosed herein;

FIG. 4 is a flow diagram indicating different stages of the method for sourcing, procuring and selling, according to the embodiments as disclosed herein;

FIG. 5 is a flowchart indicating a part of a method for sourcing and procuring for use by a buyer, according to the embodiments as disclosed herein;

FIG. 6 is a flowchart indicating another part of a method for sourcing and procuring for use by the buyer, according to the embodiments as disclosed herein;

FIG. 7 is a flowchart indicating yet another part of a method for sourcing and procuring for use by the buyer, according to the embodiments as disclosed herein;

FIG. 8 is a sequential diagram indicating a method for sourcing, procuring and selling, according to the embodiments as disclosed herein;

FIG. 9 is a table indicating information of any entities stored in the system, according to the embodiments as disclosed herein;

FIG. 10 is another table indicating information of suppliers stored in the system, according to the embodiments as disclosed herein; and

FIG. 11 is a block diagram of the system in an example form of a computer system within which instructions for performing any one or more of the methodologies discussed herein may be executed.

### DETAILED DESCRIPTION OF THE EMBODIMENTS

The above-mentioned needs are met by a computer-implemented method and system for sourcing, procuring and selling. The method and the system provide a comprehensive solution that manages entire workflow of sourcing and procuring engineering components and results in low transaction costs, reduced lead time, smoother workflow, and efficient discovery of business partners.

The following detailed description is intended to provide example implementations to one of ordinary skill in the art, and is not intended to limit the invention to the explicit disclosure, as one or ordinary skill in the art will understand that variations can be substituted that are within the scope of the invention as described.

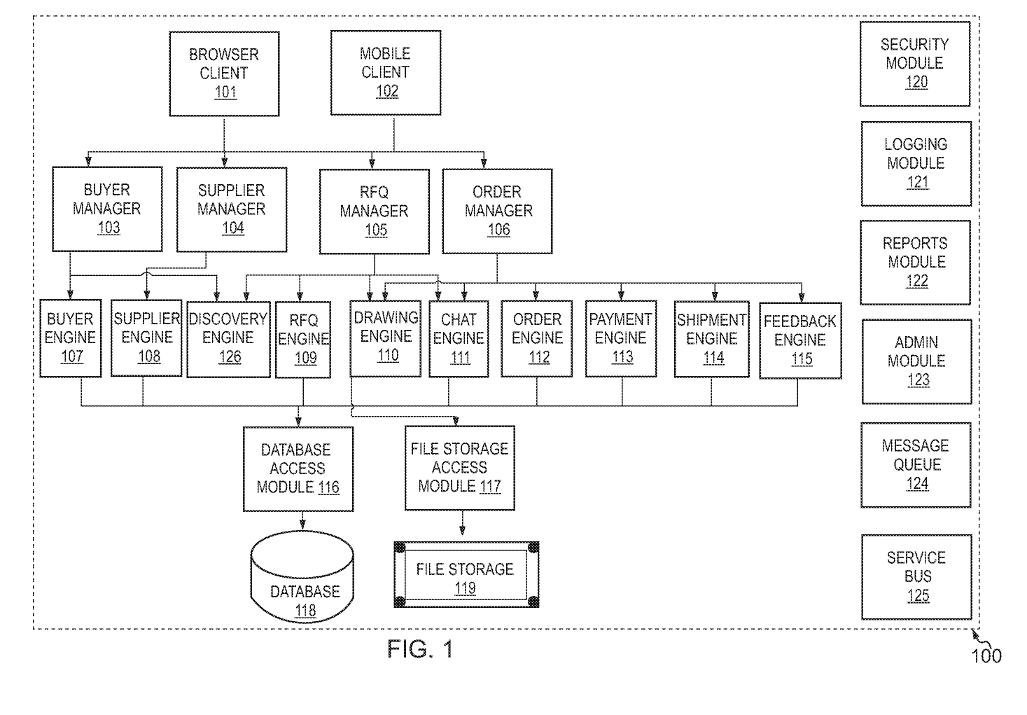

FIG. 1 is a block diagram of a system 100 for sourcing, procuring and selling, according to embodiments as disclosed herein.

### Structural Description

The system 100 is connected to a browser client 101 and a mobile client 102. The browser client 101 and the mobile client 102 can be present at a user device, for example a buyer device or a supplier device. The browser client 101 and the mobile client 102 interacts with the system 100 via a buyer manager 103, a supplier manager 104, a request for quote or a request for quotation (RFQ) manager 105, and an order manager 106, which are part of the system 100.

In one embodiment, the buyer manager 103 is further connected to a buyer engine 107 and a discovery engine 126. The supplier manager 104 is connected to a supplier engine 108. The RFQ manager 105 is connected to an RFQ engine 109, a drawing engine 110, and a chat engine 111. The RFQ manager 105 may also be connected to the discovery engine 126. The order manager 106 is connected to the drawing engine 110, the chat engine 111, an order engine 112, a payment engine 113, a shipment engine 114, and a feedback engine 115. All engines are part of the system 100.

The system 100 further includes a database 118 which can be accessed via a database access module 116 by various engines. In one embodiment, the system 100 also includes a file storage 119 which can be accessed via a file storage access module 117 by the drawing engine 110.

In some embodiments, the system 100 may also include a security module 120, a logging module 121, a reports module 122, and an admin module 123, all of which may communicate with various engines but not the browser client 101, the mobile client 102, the database 118, and the file storage 119. The system 100 may also include a message queue 124 and a service bus 125, both of which may communicate with various engines but not the browser client 101, the mobile client 102, the database 118, the database access module 116, the file storage access module 117, and the file storage 119.

### Functional Description

In one embodiment, the system 100 is a SaaS (Software as a Service) cloud-based platform or system which brings a buyer of an engineering component and various suppliers of the engineering component together and manages the procurement process effectively and efficiently.

The buyer manager 103 executable by one or more processors is configured to manage workflow initiated by the buyer. The buyer engine 107 executable by one or more processors is configured to do actual tasks like buyer registration, supplier search, etc., which may be initiated by the buyers using the buyer manager 103. In one embodiment, the buyer engine 107 performs registration of the buyer, addition of payment instruments of the buyer, management of request for quote or request for quotation (RFQ) history, management of RFQ responses, management of orders, and management of feedback received for the buyer and provided by the buyer.

The buyer accesses the platform via a user interface. The buyer performs the registration by providing various required details including payment instrument. The buyer then sees various workflows that can be performed by the buyer. In one embodiment, the buyer desires to procure the engineering component or a specialized product. In one embodiment, the specialized product may include a product that cannot be defined or explained using mere specification or a photo and hence, an engineering drawing for the product may be needed. For example, let us assume the buyer needs a special gear for machinery that the buyer is manufacturing. Special gear might have to be casted using a particular metal/alloy and then machined to correct specification, and this gear is not available in readymade market. The buyer will do the design/drawing for that gear but the buyer may not have the capability to manufacture that special gear in their manufacturing facility. Hence, the buyer would require the platform (the system 100) to source this gear from some other gear manufacturer (supplier).

The buyer creates a search request in the system 100 to search suppliers capable of providing the engineering component based on a plurality of attributes. The buyer then uploads the drawing on the system 100 using the drawing engine 110. The drawing engine 110 receives the drawing of the engineering component from the buyer, associates the drawing with an RFQ created on the system 100 for the buyer, and stores the drawing in the file storage 119 using the file storage access module 117. The drawing can be retrieved from the file storage 119 in response to a request to view drawing received from the buyer or various suppliers.

In various embodiments, the supplier manager 104 executable by one or more processors is configured to manage workflow initiated by various suppliers. The supplier engine 108 executable by one or more processors is configured to do actual tasks like supplier registration, buyer search, etc. initiated by the suppliers using the supplier manager 104. In one embodiment, the supplier engine 108 performs registration of the suppliers, addition of payment instruments, for example payment account, of the suppliers, management of request for proposal (RFP) history, management of RFP responses, management of orders, and management of feedback received for the suppliers and provided by the suppliers.

Thus, the system 100 has information of various suppliers. The system 100 enables the buyer to search for the suppliers using various search criteria, for example location, capability, overall ratings, etc. The request to search for the suppliers capable of providing the engineering component is received by the discovery engine 126. The discovery engine 126 receives the request from the buyer to search for the suppliers based on various attributes. The attributes are also referred to as search or sort criteria. Examples of the attributes include, but are not limited to, location proximity, supplier capability, ratings, feedback, etc. The attributes could include any parameter that the buyer wants to be considered in search/sort criteria.

The discovery engine 126 processes the search/sort request based on the search/sort criteria using the search/sort algorithm described now. The discover engine 126 also sets maximum and minimum value for each attribute, assigns weightage to each attribute, and determines an aggregate relevance score for the suppliers using the plurality of attributes. The discovery engine 126 further determines an influencer type for each attribute, wherein a positive value of the influencer type indicates higher value of that attribute and higher relevance given to corresponding supplier, and a negative value of the influencer type indicates higher value of that attribute and lower relevance given to corresponding supplier. The discovery engine 126 also determines the aggregate relevance score by calculating relevance score for each attribute for a respective supplier as

Relevance Score=(Parameter value/maximum value of attribute)*weightage, if influencer type is positive.

Relevance Score=(1−(Parameter value/maximum value of attribute))*weightage, if influencer type is negative

The discovery engine 126 further aggregates relevance score for each attribute in the plurality of attributes for the respective supplier to determine the aggregated relevance score for the respective supplier, wherein the parameter value is an attribute value associated with the respective supplier. The discovery engine 126 also sorts the suppliers in descending order of the aggregated relevance score. The discovery engine 126 finally returns the search/sort result with the list of suppliers matching the search/sort criteria.

Algorithm

Suppliers: Group of suppliers which need to be sorted/searched based on the search/sort criteria.

Sort Criteria: Attributes of the supplier that are used to determine the relevance of the supplier in the search/sort.

Minimum and maximum value: Minimum and maximum value sets the range of possible values for the sort criteria. It is also used to filter out the suppliers that have the parameter value outside the range.

Influencer type: If the sort criteria's influencer type is positive, it means that higher the value of that parameter, more the relevance is given to that entity in the sort process. If the sort criteria's influencer type is negative, it means that higher the value of that parameter, less the relevance is given to that entity in the sort process.

Weightage: Weightage allows the discovery engine 126 to set the importance level of the sort criteria in determining the relevance of the supplier that is being searched/sorted. The buyer can also assign different weightage to different sort criteria. The total of the weightage of the plurality of the attributes should add up to 1.

Parameter Value: Attribute value associated to the supplier based on the relevant sort criteria

Relevance Score Calculation: This shows how the relevance score is calculated for each of the sort attribute

Aggregate Relevance Score: This gives the aggregate relevance score for the supplier. This is calculated by taking the summation of all the relevance scores associated to the plurality of the supplier attributes (i.e. sort criteria).

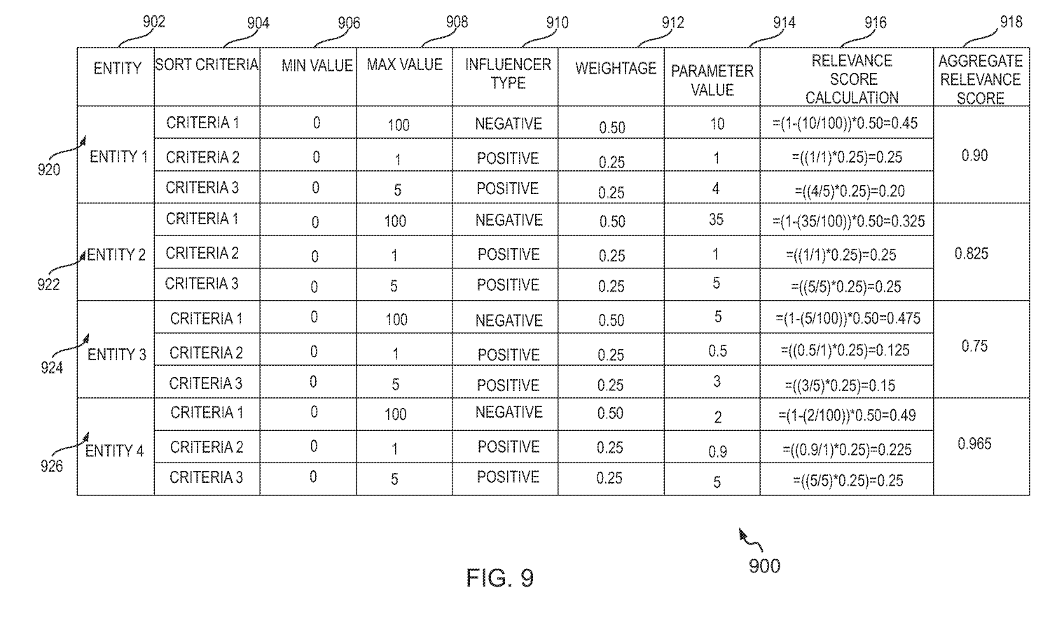

Let us assume group of suppliers need to be searched/sorted based on 3 sort criteria as shown Table 900 of FIG. 9. Each one of the sort criteria 904 has associated minimum value (min value) 906, maximum value (max value) 908, influencer type 910, weightage 912 and parameter value 914.

Step 1: Filter in suppliers (entities/entity 902), for example entity 1 (920), entity 2 (922), entity 3(924), entity 4 (926), only with parameter value that falls within the minimum and maximum value for the sort criteria

Step 2: Determine the influencer type 910 for each one of the sort criteria 904

Step 3: Determine the weightage 912 that needs to be applied for each one of the sort criteria 904

Step 4: Determine the parameter (attribute) value 914 for each one of the sort criteria 904

Step 5: Calculate the relevance score 916 for each one of the sort criteria 904

a) If the sort criteria's influencer type 910 is positive, it means that higher the value of that parameter, more the relevance is given to that supplier in the search/sort process.

Relevance score 916=(Parameter value 914/maximum value 908 of sort criteria 904)*Weightage 912

b) If the sort criteria's influencer type 910 is negative, it means that higher the value of that parameter, less the relevance is given to that supplier in the search/sort process.

Relevance score 916=(1−(Parameter value 914/maximum value 908 of sort criteria 904))*Weightage 912

Step 6: Calculate the aggregate relevance score 918 for every supplier in the group by taking the summation of all the relevance scores associated to the plurality of the supplier attributes (i.e. sort criteria 904)

Step 7: Sort the suppliers based on the aggregate relevance scores 918 in descending order (i.e. Suppliers with highest relevance score go to the top of the search/sort result and suppliers with lowest relevance score go to the bottom of the search/sort result)

Based on the algorithm, the search/sort result would show the entities in the following order Entity 4 (supplier 4), Entity 1 (supplier 1), Entity 2 (supplier 2), and Entity 3 (supplier 3).

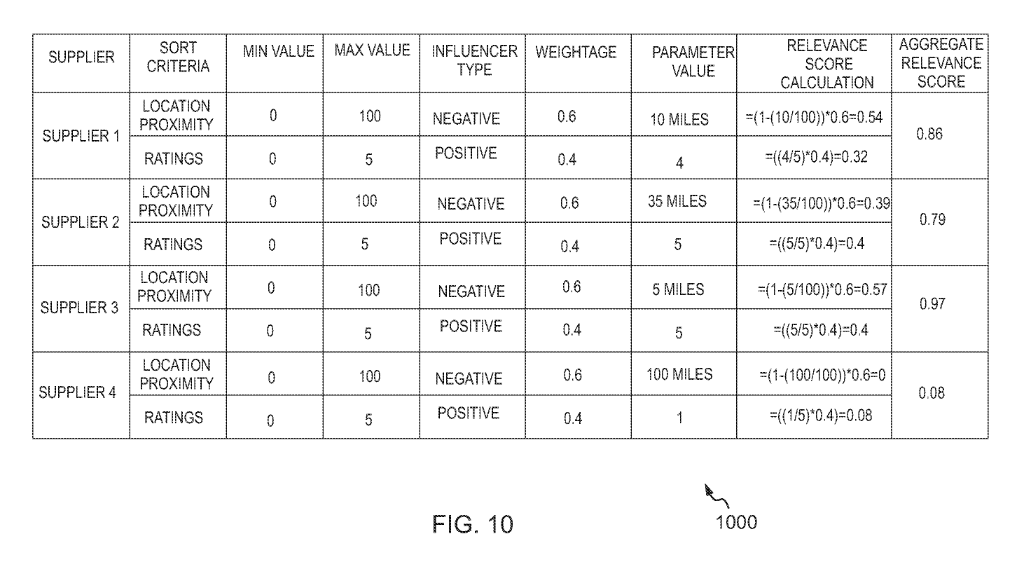

Applying the algorithm to an example, let us consider the buyer is looking for a special gear made of cast iron manufactured by casting process and then machining process. So, the buyer specifies the suppliers to have the capability of both casting and machining The discovery engine 126 filters only the suppliers with those 2 capabilities. Let us assume, 4 suppliers are returned after the filtering. Also, let us assume the buyer applies 0.6 weightage on location proximity and 0.4 weightage on ratings. Both the weightage and min/max parameter value is configurable in this algorithm. Next, the minimum value, maximum value and influencer type is configured by the user for each one of the search criteria as shown in Table 1000 of FIG. 10. Now these 4 suppliers need to be sorted based on the relevance score. Based on the algorithm, the search/sort result would show the suppliers in the following order Supplier 3, Supplier 1, Supplier 2, and Supplier 4.

The RFQ manager 105 executable by one or more processors is configured to manage the workflow for creating the RFQ and sending it to the shortlisted suppliers. The RFQ engine 109 executable by one or more processor is configured to do the actual tasks of creating RFQ, sending RFQ to suppliers, sending response for RFQ to the buyers, etc.

The buyer could then choose the suppliers and create RFQ and send it to the shortlisted suppliers. The system 100 also allows the buyer to compare the responses for the RFQ received from multiple suppliers based on the sort criteria or any other criteria, and facilitate the buyer to choose at least one supplier. The RFQ engine 109 generates the RFQ to be sent to the suppliers by the buyer, and receives response to the RFQ by the buyer from the suppliers, wherein the buyer and the suppliers access the drawing associated with the RFQ. The RFQ engine 109 enables the buyer and the suppliers to perform various other functions including the buyer to send the RFQ to the selected suppliers, the suppliers to send RFQ response to the buyer, the suppliers to send request for information (RFI) to the buyer, the suppliers to send RFI response to the buyer, the buyer to send RFI to the suppliers, and the buyer to send RFI response to the suppliers. The suppliers could request for missing information if any and then send the response for the RFQ.

The order manager 106 executable by one or more processors is configured to manage the workflow for handling the order process. The order engine 112 executable by one or more processors is configured to allow the buyer to send the purchase order to the selected supplier and the selected supplier to send Order Acceptance/Order Rejection to the buyer. The order engine 112 facilitates order for the engineering component, wherein the order is placed by the buyer to a supplier selected from the shortlisted suppliers. The order engine 112 creates purchase order for the buyer, sends the purchase order from the buyer to the selected supplier, and creates and sends order acceptance or order rejection from the selected supplier to the buyer.

In some embodiments, the system 100 also includes the chat engine 111 executable by a processor and configured to allow the buyer and suppliers to message to each other, and facilitate message exchange among the buyer and the suppliers. The suppliers could also request for information via the chat engine 111 and discuss information about order execution.

The system 100 also includes the payment engine 113 executable by a processor and configured to allow the selected supplier to raise the invoice to the buyer on order completion, to allow the buyer to make the payment to the supplier, and to allow the supplier to send payment receipt. The payment engine 113 facilitates the payment to the supplier by processing payments from buyer and crediting to the supplier, and processing payment adjustments.

The shipment engine 114 executable by one or more processors is configured to allow the buyer and/or the supplier to arrange for the shipment of order and to send the shipment details to various entities. In one embodiment, the shipment engine 114 facilitates creation of the invoice for the order, shipment of the order, packing list and Bill of Lading after order completion, finding quotes from shipping companies to air freight, sea freight or land freight the order. The shipment engine 114 could use the discovery engine 126 to search for shipping companies.

In some embodiments, the system 100 also includes the feedback engine 115 executable by one or more processors and configured to allow the buyers/sellers to provide feedback and ratings. Both buyers and suppliers could provide feedback and ratings regarding the business transaction. The feedback engine 115 is also responsible for collecting feedback and rating from both the suppliers and the buyer, and persisting them for future use. The feedback engine 115 can further aggregate rating for both the suppliers and the buyer so that it could be used in the discovery engine 126.

In various embodiments, the database access module 116 and the file storage access module 117 are used by various engines to store data/information in the database 118 and drawing files in the file storage 119.

In some embodiments, the system 100 also includes the security module 120 for security purposes, the logging module 121 for enabling login, the reports module 122 for generating reports, the admin module 123 for providing administrator control for both buyers and sellers, the message queue 124 and the service bus 125 for providing event driven architecture to provide infrastructure needed for the system 100 to provide desired functionality and perform method disclosed herein.

In one embodiment, the system 100 is embodied in the form of service oriented architecture (SOA), application programming interfaces (APIs), and data storage. In some embodiments, the system 100 is embodied in the form of API gateway, micro services, message queue, service bus, data storage including relational database, file server, non-relational database and in-memory cache. In some embodiments, the system 100 is embodied in the form of desktop application. In another embodiment, the system 100 is embodied in form of client server architecture. Also, the system 100 can be embodied with various combinations of above mentioned architectures.

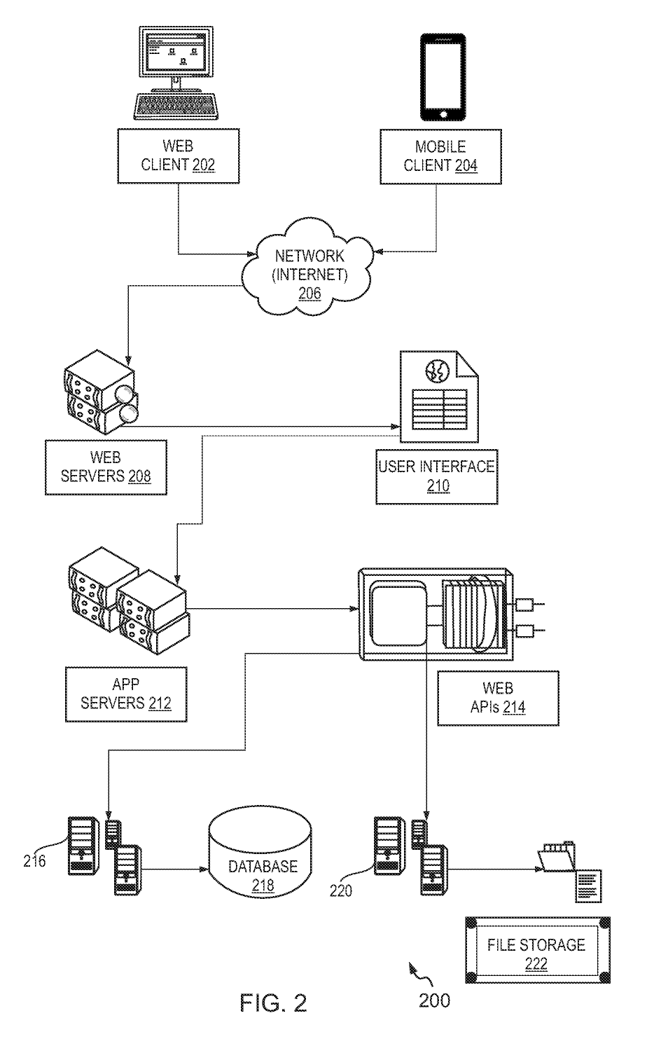

FIG. 2 illustrates an environment 200, in which various embodiments disclosed herein may be practiced. The environment 200 includes a web client 202 and a mobile client 204. The web client 202 or the mobile client 204 can be present in the buyer device or the supplier device. The environment 100 includes one or more buyer devices and a plurality of supplier devices. The buyer or the supplier can access user interface of the system 100 via their respective devices.

The buyer device and the suppliers' devices are connected to the system 100 via a network internet 206. The user interfaces accessible by the devices may be deployed over a web server 208. For example, the user interfaces 210 for the browser client 101 and the mobile client 102 can be deployed to the web server 208. Various other components of the system 100 could be deployed to one or more application (app) servers 212. The system 100 is also referred to as a server. The database 118/218 can be deployed to one or more database servers 216. The file storage 119/222 can be deployed to one or more file servers 220. The data in the database 118 and the file storage 222 can be exposed via web APIs 214.

Examples of the buyer device or the supplier device include, but are not limited to, computer, laptop, notebook, tablet, mobile device, smartphone, and other devices including at least one processor.

Examples of the system 100 include, but are not limited to, computer, server, and other devices including at least one processor.

The system 100 is configured with a machine-readable/computer-readable medium or a processing system or a firmware, the contents or machine readable code of which causes the system 100 to perform the method disclosed herein.

The network internet 206 may include any suitable number or arrangement of interconnected networks including both wired and wireless networks. By way of example, a wireless communication network link over which mobile devices communicate may utilize a cellular-based communication infrastructure. The communication infrastructure includes cellular-based communication protocols such as AMPS, CDMA, TDMA, GSM (Global System for Mobile communications), iDEN, GPRS, EDGE (Enhanced Data rates for GSM Evolution), UMTS (Universal Mobile Telecommunications System), WCDMA and their variants, among others. In various embodiments, the network internet 206 may further include, or alternately include, a variety of communication channels and networks such as WLAN/Wi-Fi, WiMAX, Wide Area Networks (WANs), and Blue-Tooth.

### Operational Flow Chart

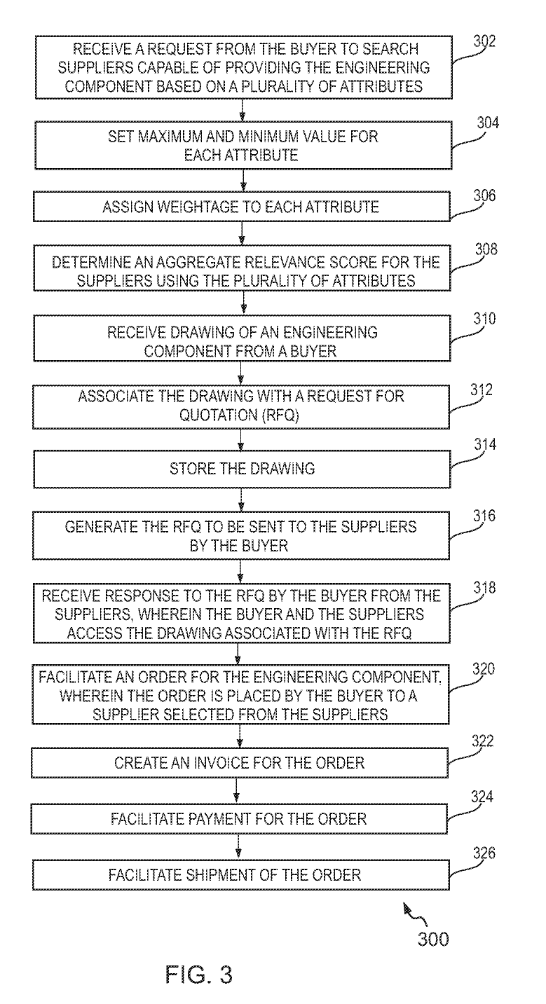

FIG. 3 is a flowchart indicating a method 300 for sourcing, procuring and selling, according to embodiments as disclosed herein.

It is to be appreciated that order of steps shown in FIG. 3 is a mere example order and the order may vary in different embodiments. For example, in one embodiment step 316 may be performed before step 312.

At step 302, a request is received from a buyer to search suppliers capable of providing an engineering component based on a plurality of attributes.

At step 304, maximum and minimum value is set for each search/sort attribute.

At step 306, weightage is assigned to each search/sort attribute.

In some embodiments, the method 300 also includes determining an influencer type for each attribute, wherein a positive value of the influencer type indicates higher value of that attribute and higher relevance given to corresponding supplier, and a negative value of the influencer type indicates higher value of that attribute and lower relevance given to corresponding supplier.

At step 308, an aggregate relevance score is determined for the suppliers using the plurality of attributes. A relevance score for each search/sort attribute for a respective supplier is calculated as

Relevance Score=(Parameter value/maximum value of attribute)*weightage, if influencer type is positive

Relevance Score=(1−(Parameter value/maximum value of attribute))*weightage, if influencer type is negative.

The relevance score for each attribute in the plurality of attributes is aggregated for the respective supplier to determine the aggregated relevance score for the respective supplier, wherein the parameter value is an attribute value associated with the respective supplier. The suppliers are then sorted in order of descending order of the aggregate relevance score.

At step 310, a drawing of the engineering component is received from the buyer.

At step 312, the drawing is associated with corresponding RFQ.

At step 314, the drawing is stored.

At step 316, the RFQ to be sent to the suppliers by the buyer is generated.

At step 318, a response to the RFQ is received by the buyer from the suppliers, wherein the buyer and the suppliers access the drawing associated with the RFQ.

At step 320, an order for the engineering component is facilitated, wherein the order is placed by the buyer to a supplier selected from the suppliers. Facilitating of the order includes creating purchase order for the buyer, sending the purchase order from the buyer to the supplier, and creating and sending order acceptance or order rejection from the supplier to the buyer.

At step 322, an invoice for the order, from supplier to buyer, is created.

At step 324, payment for the order, from buyer to supplier, is facilitated.

At step 326, shipment of the order is facilitated.

In some embodiments, the method 300 further includes registering the buyer, adding payment instruments of the buyer, managing RFQ history of the buyer, managing RFQ responses of the buyer, managing orders of the buyer, and managing feedback received for the buyer and provided by the buyer.

The method 300 further includes registering the suppliers, adding payment instruments of the suppliers, managing request for proposal (RFP) history, managing RFP responses, managing orders, and managing feedback received for the suppliers and provided by the suppliers.

The method 300 also includes facilitating message exchange among the buyer and the suppliers. The method 300 also includes collecting feedback and rating from the suppliers and the buyer, and persisting the feedback and the rating for future use, and aggregating the rating for the suppliers and the buyer.

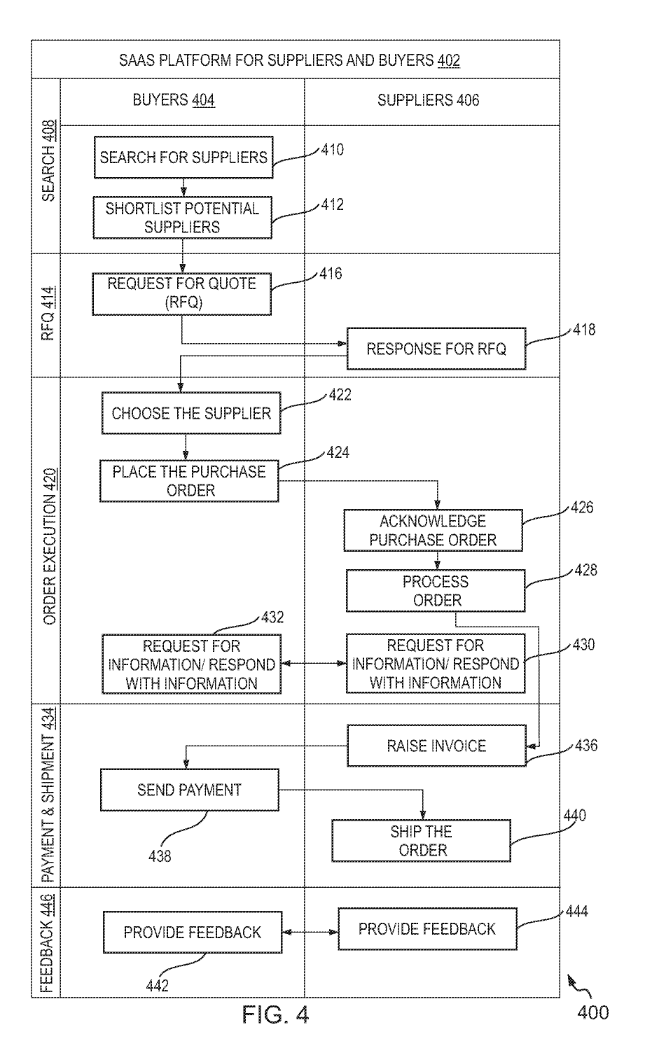

FIG. 4 is a flow diagram 400 indicating different stages of the method for sourcing, procuring and selling, according to the embodiments as disclosed herein. The method can be implemented using a SaaS platform for suppliers and buyers 402. A buyer from buyers 404 performs a search 408 for suppliers 406. The search is performed at 410 followed by shortlisting of potential suppliers at 412.

A RFQ 414 is generated at 416. A response for RFQ is received at 418.

In order execution 420 one supplier is selected at 422 and an order for placing the purchase is placed at 424. Purchase order is acknowledged at 426 and the order is processed at 428 A request for information and/or response with information(if any) is sent at 430 and a response is received(if any) at 432. An invoice is raised at 436 to process payment and shipment 434. At 438 payment is sent and the order is shipped at 440.

At 442 and 444, feedback 446 is provided and received.

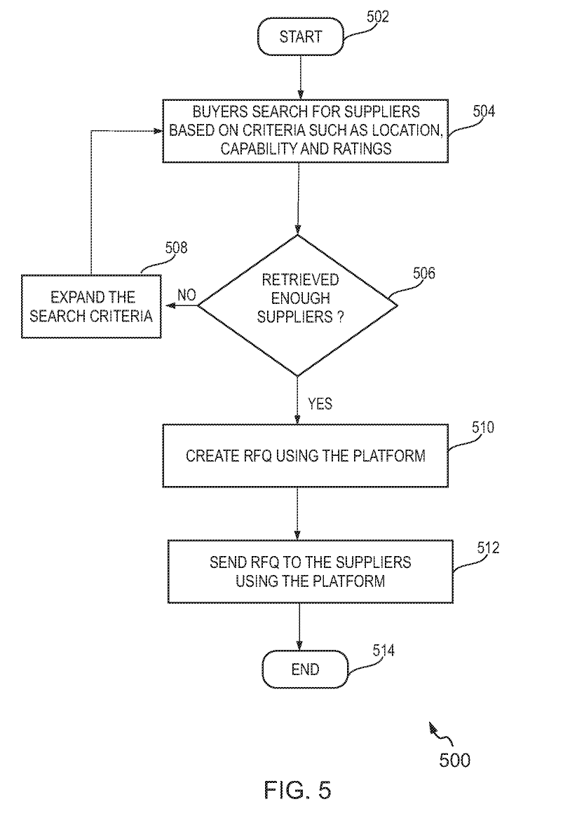

FIG. 5 is a flowchart indicating a part of a method 500 for sourcing and procuring for use by a buyer, according to the embodiments as disclosed herein. The method starts at step 502. At step 504, search for suppliers based on search criteria such as location, capability, and ratings is received. At step 506, a check is made if enough suppliers are retrieved. If not then at step 508, the search criteria are expanded. If yes then at step 510, RFQ is created. At step 512, RFQ is sent to the suppliers. The method ends at step 514.

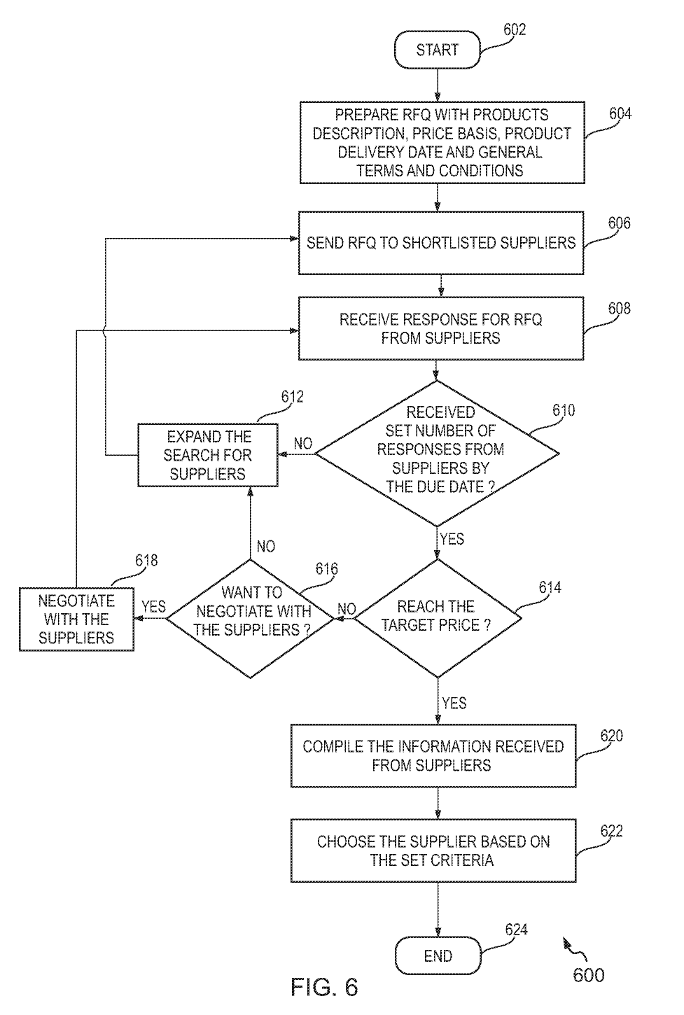

FIG. 6 is a flowchart indicating another part of a method 600 for sourcing and procuring for use by the buyer, according to the embodiments as disclosed herein. The method starts at step 602. At step 604, RFQ with product description, price basis, product delivery date, and general terms and conditions are prepared. At step 606, RFQ is sent to the shortlisted suppliers. At step 608, response for RFQ is received from the suppliers. At step 610, a check is performed to determine if set number of responses from suppliers are received by the due date. If no then at step 612, the search for suppliers is expanded, else at step 614 a check is performed to see if the target price is reached. If no then a check is made at step 616 to determine if negotiation with the suppliers is to be performed. If no then step 612 is performed. If yes then negotiation happens at step 618. At step 620, the information received from the suppliers is compiled if the target price is reached at step 614. At step 622, the supplier is chosen based on set criteria. The method ends at step 624.

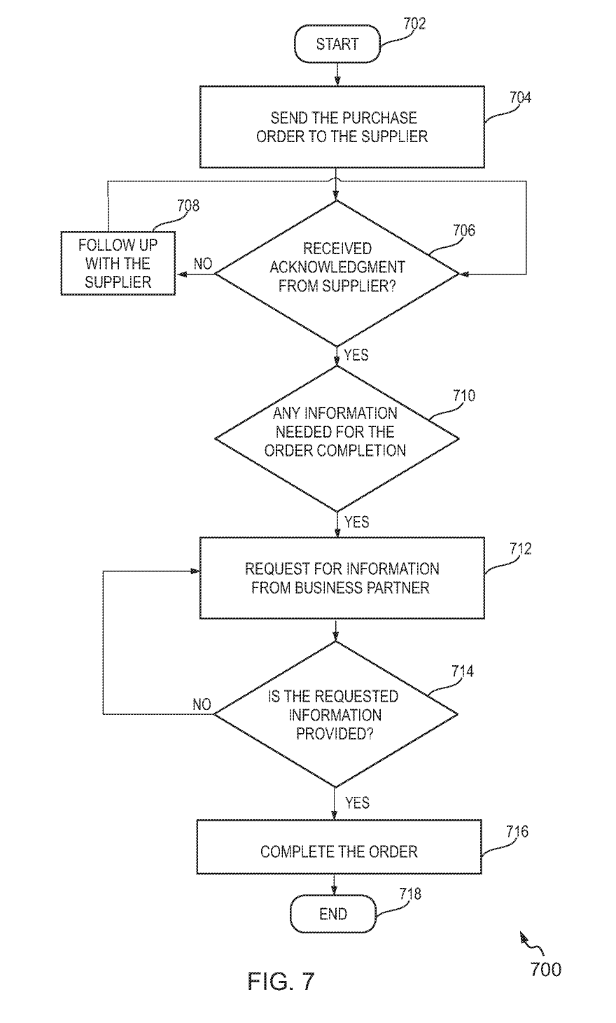

FIG. 7 is a flowchart indicating yet another part of a method 700 for sourcing and procuring for use by the buyer, according to the embodiments as disclosed herein. The method starts at step 702. At step 704, purchase order is sent to the supplier. At step 706, a check is made to determine if acknowledgement is received from the supplier. If no then at step 708 a follow up is done with supplier else at step 710 a check is made if any further information is needed. If further information is needed then at step 712 request for information is sent from business partner (supplier). At step 714, a check is made for the requested information. If yes then the order is completed at step 716 and the method ends at step 718. If not then step 712 is performed.

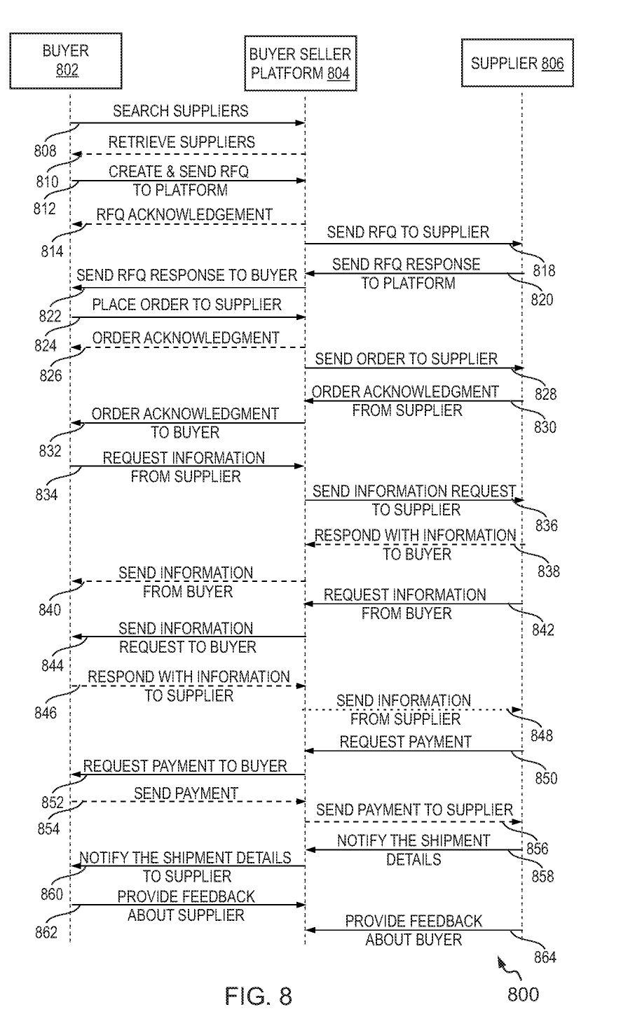

FIG. 8 is a sequential diagram indicating a method 800 for sourcing, procuring and selling, according to the embodiments as disclosed herein. At step 808, a buyer 802 searches for suppliers using a buyer seller platform 804 (the platform 804). At step 810, the suppliers are retrieved. At step 812 RFQ is created and sent to the platform 804. At step 814, RFQ acknowledgement is received by the buyer 802. At step 818, RFQ is sent to the supplier 806. At step 820, RFQ response is sent to the platform 804. At step 822, RFQ response is send to the buyer 802. At step 824, the order is placed with the platform 804 and at step 826 the acknowledgement for the order is received. At step 828, the order is sent to the supplier 806 and at step 830 the acknowledgement is received from the supplier 806. At step 832, the order acknowledgement is received by the buyer 802. At step 834, request for information from supplier is sent to the platform 804 which is forwarded to the supplier 806 at step 836. At step 838, response to the information request is received which is then sent to the buyer 802 at step 840. The supplier 806 may also similarly request for information from the buyer 802 at steps 842 and 844, and the buyer 802 may respond to that information at steps 846 and 848. At step 850, payment request is sent to the platform 804 which is then forwarded to the buyer 802 at step 852. The payment is performed at steps 854 and 856. At steps 858 and 860, the shipment details are notified. At steps 862 and 864, feedback is received.

Various embodiments disclosed herein provide end to end process of sourcing and procuring specialized products which eliminates the need to use multiple disparate systems to manage this process and thereby eliminating the interoperability issues of using multiple disparate systems. This also eliminates the chances of data error in the process of manual entry of data from one system to another. All these advantages of this platform lead to much smoother, efficient and error free process of sourcing and procuring specialized products. In addition, this platform helps the buyer to discover the suppliers and supplier to discover the buyers in an efficient manner by removing the information asymmetry that exist otherwise. This platform significantly reduces both the time and cost in discovering the business partners by readily available information. Further, this platform provides better visibility into sourcing and procurement activities by integrating the complex process of sourcing and procurement into a single integrated end to end solution.

### Example Computer System

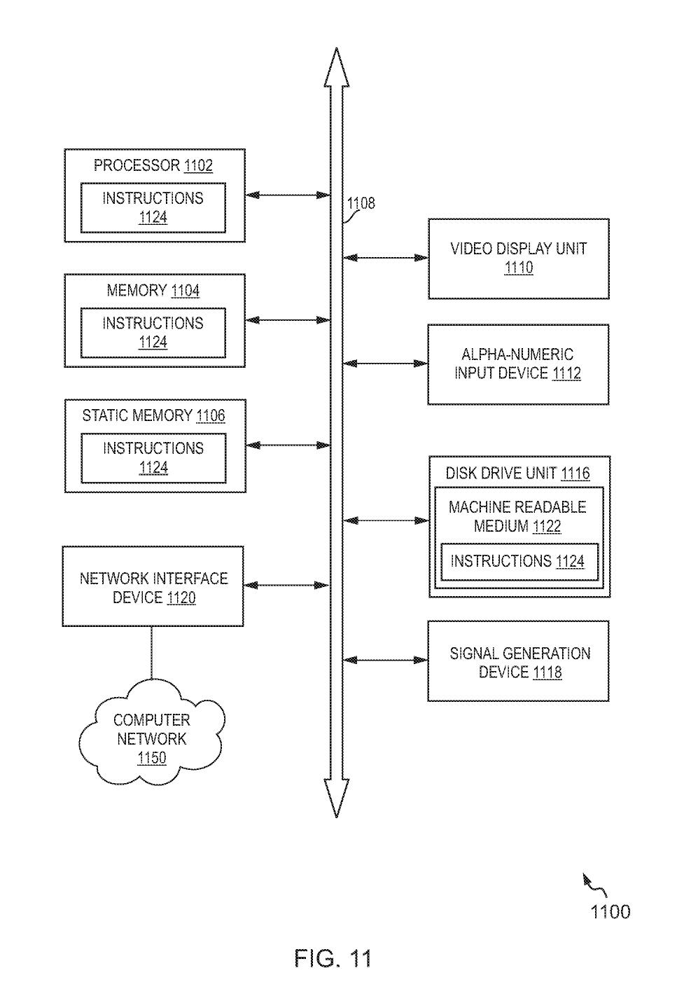

FIG. 11 is a block diagram of the system 1100 in an example form of a computer system within which instructions for performing any one or more of the methodologies discussed herein may be executed.

The system 1100 includes a processor 1102 (e.g., a central processing unit (CPU), a microcontroller (or MCU for microcontroller unit), a graphics processing unit (GPU), or both), a main memory 1104, and a static memory 1106, which communicate with each other via a bus 1108. The system 1100 may further include a video display unit 1110 (e.g., a light emitting diode display (LED), a liquid crystal display (LCD) or a cathode ray tube (CRT)). The system 1100 may also include an alphanumeric input device 1112, a disk drive unit 1116, a signal generation device 1118 (e.g., a speaker), and a network interface device 1120.

### Machine-Readable Medium

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “non-transitory machine-readable medium” shall also be taken to include any tangible medium that is capable of storing, encoding, or carrying instructions for execution by the machine and that cause the machine to perform anyone or more of the methodologies of the present subject matter, or that is capable of storing, encoding, or carrying data structures utilized by or associated with such instructions. The term “non-transitory machine-readable medium” shall accordingly be taken to include, but not be limited to, solid-state memories, and optical and magnetic media. Specific examples of non transitory machine-readable media include, but are not limited to, non-volatile memory, including by way of example, semiconductor memory devices (e.g., Erasable Programmable Read-Only Memory (EPROM), Electrically Erasable Programmable Read-Only Memory (EEPROM), and flash memory devices), magnetic disks such as internal hard disks and removable disks, magneto-optical disks, and CD-ROM and DVD-ROM disks.

### Transmission Medium

The instructions 1124 may further be transmitted or received over a network 1150 using a transmission medium. The instructions 1124 may be transmitted using the network interface device 1120 and any one of a number of well-known transfer protocols (e.g., HTTP). Examples of communication networks include a local area network (LAN), a wide area network (WAN), the Internet, mobile telephone networks, Plain Old Telephone Service (POTS) networks, and wireless data networks (e.g., Wi-Fi and WiMAX networks). The term “transmission medium” shall be taken to include any intangible medium that is capable of storing, encoding, or carrying instructions for execution by the system 1100, and includes digital or analog communications signals or other intangible media to facilitate communication of such software.

As described herein, computer software products can be written in any of various suitable programming languages, such as C, C++, C#, VB.Net, Python, Pascal, Fortran, Perl, Ruby, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans or Enterprise JavaBeans. Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standard 802.11 including its sub-standards a, b, e, g, h, i, n, et al.). In one example, signals from the computer can be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A SaaS (software as a service) cloud-based system for sourcing, procuring and selling engineering components, the system comprising:
a discovery engine for
receiving a request from a buyer to search suppliers capable of providing an engineering component based on a plurality of attributes,
setting maximum and minimum value for each attribute of the plurality of attributes, assigning weightage to each attribute of the plurality of attributes, and
determining an aggregate relevance score for the suppliers using the plurality of attributes;
a drawing engine for receiving drawing of the engineering component from the buyer, associating the drawing with a request for quotation (RFQ), and storing the drawing;
a RFQ engine for generating the RFQ to be sent to the suppliers by the buyer, and for receiving response to the RFQ by the buyer from the suppliers, wherein the buyer and the suppliers access the drawing associated with the RFQ;
an order engine for facilitating an order for the engineering component, wherein the order is placed by the buyer to a supplier selected from the suppliers;
a payment engine to facilitate payment for the order; and
a shipment engine for creating an invoice for the order and facilitating shipment of the order.

2. The system as claimed in claim 1 and further comprising a buyer engine for:
registration of the buyer;
adding payment instruments of the buyer;
managing RFQ history;
managing RFQ responses;
managing orders; and
managing feedback received for the buyer and provided by the buyer.

3. The system as claimed in claim 1 and further comprising a supplier engine for:
registration of the suppliers;
adding payment instruments of the suppliers;
managing request for proposal (RFP) history;
managing RFP responses;
managing orders; and
managing feedback received for the suppliers and provided by the suppliers.

4. The system as claimed in claim 1 and further comprising a chat engine for facilitating message exchange among the buyer and the suppliers.

5. The system as claimed in claim 1 and further comprising a feedback engine for:
collecting feedback and rating from the suppliers and the buyer, and persisting the feedback and the rating for future use; and
aggregating the rating for the suppliers and the buyer for use by the discovery engine.

6. The system as claimed in claim 1, wherein the discovery engine further determines an influencer type for each attribute, wherein:
a positive value of the influencer type indicates higher value of that attribute and higher relevance given to corresponding supplier; and
a negative value of the influencer type indicates higher value of that attribute and lower relevance given to corresponding supplier.

7. The system as claimed in claim 6, wherein the discovery engine determines the aggregate relevance score by
calculating relevance score for each attribute for a respective supplier as
Relevance Score=(Parameter value/maximum value of attribute)*weightage (if the influencer type is positive)
Relevance Score=(1−(Parameter value/maximum value of attribute))*weightage (if the influencer type is negative); and
aggregating relevance score for each attribute in the plurality of attributes for the respective supplier to determine the aggregated relevance score for the respective supplier,
wherein the parameter value is an attribute value associated with the respective supplier.

8. The system as claimed in claim 7, wherein the discovery engine further sorts the suppliers in descending order of the aggregated relevance score.

9. The system as claimed in claim 1, wherein the order engine further creates purchase order for the buyer;
sends the purchase order from the buyer to the supplier; and
creates and sends order acceptance or order rejection from the supplier to the buyer.

10. A method for sourcing, procuring and selling engineering components, the method comprising:
receiving a request from a buyer to search suppliers capable of providing an engineering component based on a plurality of attributes;
setting maximum and minimum value for each attribute,
assigning weightage to each attribute,
determining an aggregate relevance score for the suppliers using the plurality of attributes;
receiving drawing of the engineering component from the buyer;
associating the drawing with a request for quotation (RFQ);
storing the drawing;
generating the RFQ to be sent to the suppliers by the buyer;
receiving response to the RFQ by the buyer from the suppliers, wherein the buyer and the suppliers access the drawing associated with the RFQ;
facilitating an order for the engineering component, wherein the order is placed by the buyer to a supplier selected from the suppliers;
facilitating payment for the order;
creating an invoice for the order; and
facilitating shipment of the order.

11. The method as claimed in claim 10 and further comprising:
registering the buyer;
adding payment instruments of the buyer;
managing RFQ history of the buyer;
managing RFQ responses of the buyer;
managing orders of the buyer; and
managing feedback received for the buyer and provided by the buyer.

12. The method as claimed in claim 10 and further comprising:
registering the suppliers;
adding payment instruments of the suppliers;
managing request for proposal (RFP) history of the suppliers;
managing RFP responses of the suppliers;
managing orders of the suppliers; and
managing feedback received for the suppliers and provided by the suppliers.

13. The method as claimed in claim 10 and further comprising facilitating message exchange among the buyer and the suppliers.

14. The method as claimed in claim 10 and further comprising:
collecting feedback and rating from the suppliers and the buyer, and persisting the feedback and the rating for future use; and
aggregating the rating for the suppliers and the buyer.

15. The method as claimed in claim 10 and further comprising determining an influencer type for each attribute, wherein
a positive value of the influencer type indicates higher value of that attribute and higher relevance given to corresponding supplier; and
a negative value of the influencer type indicates higher value of that attribute and lower relevance given to corresponding supplier.

16. The method as claimed in claim 15, wherein determining the aggregate relevance score comprises:
calculating relevance score for each attribute for a respective supplier as
Relevance Score=(Parameter value/maximum value of attribute)*weightage (if the influencer type is positive)
Relevance Score=(1−(Parameter value/maximum value of attribute))*weightage (if the influencer type is negative); and
aggregating relevance score for each attribute in the plurality of attributes for the respective supplier to determine the aggregated relevance score for the respective supplier,
wherein the parameter value is an attribute value associated with the respective supplier.

17. The method as claimed in claim 16 and further comprising sorting the suppliers in descending order of the aggregated relevance score.

18. The method as claimed in claim 10, wherein facilitating the order comprises:
creating purchase order for the buyer;
sending the purchase order from the buyer to the supplier; and
creating and sending order acceptance or order rejection from the supplier to the buyer.

19. A server comprising:
a memory to store instructions; and
a processor responsive to the instructions stored in the memory to perform a method for sourcing, procuring and selling engineering components, the method comprising:
receiving a request from a buyer to search suppliers capable of providing an engineering component based on a plurality of attributes;
setting maximum and minimum value for each attribute,
assigning weightage to each attribute,
determining an aggregate relevance score for the suppliers using the plurality of attributes;
receiving drawing of the engineering component from the buyer;
associating the drawing with a request for quotation (RFQ);
storing the drawing;
generating the RFQ to be sent to the suppliers by the buyer;
receiving response to the RFQ by the buyer from the suppliers, wherein the buyer and the suppliers access the drawing associated with the RFQ;
facilitating an order for the engineering component, wherein the order is placed by the buyer to a supplier selected from the suppliers;
facilitating payment for the order;
creating an invoice for the order; and
facilitating shipment of the order.

20. The server as claimed in claim 19, wherein facilitating the order comprises:
creating purchase order for the buyer;
sending the purchase order from the buyer to at least one supplier; and
creating and sends order acceptance or order rejection from the at least one supplier to the buyer.
